(19) United States
(12) Patent Application Publication
(10) Pub. No.: US 2026/0201274 A1
(43) Pub. Date: Jul. 16, 2026

(54) DILUTION THICKENING SURFACTANT CONCENTRATES

(71) Applicant: Lubrizol Advanced Materials, Inc., Cleveland, OH (US)

(72) Inventors: Akanksha Sharma, Mumbai (IN); Nirav Kothari, Mumbai (IN); Mandar Lone, Mumbai (IN)

(73) Assignee: Lubrizol Advanced Materials, Inc., Cleveland, OH (US)

(21) Appl. No.: 18/868,454

(22) PCT Filed: May 31, 2023
(86) PCT No.: PCT/US2023/023950

§ 371 Date: Nov. 22, 2024

Related U.S. Application Data
(60) Provisional application No. 63/347,727, filed on Jun. 1, 2022.

(51) Int. Cl. C11D 1/831; C11D 1/22; C11D 1/66; C11D 1/722; C11D 1/83

(52) U.S. Cl. CPC C11D 1/831; C11D 1/22; C11D 1/662; C11D 1/722; C11D 1/8305

(57) ABSTRACT

The present technology relates to dilution thickening surfactant concentrates and cleaning compositions prepared from same. The neat concentrate upon dilution with water exhibits a viscosity higher than the viscosity of the neat concentrate before dilution. The dilution thickening surfactant concentrate comprises: (a) a surfactant chassis comprising (i) a nonionic surfactant component comprising a fatty alcohol ethoxylate and a polysorbate; and (ii) an anionic surfactant component comprising a C₁₀-C₁₆ alkylbenzene sulfonic acid and salts thereof; (b) a polyethoxylated alkyl glucoside ester component; (c) one or more electrolytes; (d) optionally one or more benefit agent(s); and (e) water. Methods of preparing the neat concentrate are also disclosed.

### TECHNOLOGICAL FIELD

The present technology relates to dilution thickening surfactant concentrates and cleaning compositions prepared from same. In one aspect, the present technology provides a neat, concentrated surfactant containing composition that upon the addition of water, the diluted concentrate exhibits a viscosity higher than the viscosity of the neat concentrate. The dilution thickening concentrate can be adapted for preparing liquid compositions for home care cleaning applications.

### BACKGROUND

Increasingly, consumers are insisting that manufacturers provide sustainable and environmentally friendly home care products while maintaining product performance expectations. A current trend in this regard is the provision of highly concentrated products that can be diluted by the consumer end-user to concentrations suitable for the final use. The availability of highly concentrated, low viscosity products instead of ready-to-use formulations has several advantages. For instance, the costs and ecological harm associated with manufacturing, packaging and transportation are considerably lowered, since the viscosity and water content of the product is significantly reduced.

Reduced viscosities during the preparation of the concentrated product lowers the shear forces needed for the mixing of components, thus reducing energy consumption during the manufacturing process. Reduction of the water content of the end product allows for the rationalization of product containers and reduces fuel costs during shipping. Moreover, a concentrated product reduces retail shelf space at the point of sale.

Suitable dilutable concentrated compositions are those products characterized by a set of features which enable the final consumer to practically use the product. One of the most important features of the concentrated product is having the appropriate viscosity profile, i.e., an increased viscosity of the diluted product compared with the concentrated product. The concentrated product must be homogeneous, pH and phase stable, easily pourable and clear. Additionally, the concentrated product must easily incorporate water and be mixed by manual shaking or stirring to prepare the diluted end product. The resulting diluted end product must be homogeneous, while showing higher viscosity profiles than the initial concentrate. A high enough viscosity profile is necessary in order for the end user to handle the product and control the amount of product spread onto a sponge, dish cloth or the substrate to be cleaned. Such rheological properties are advantageous for the cleaning of hard surfaces as they prevent product run off when applied to vertical surfaces. At the same time, the diluted product cannot be too viscous, as highly viscous products do not flow easily making use difficult for dosing and spreading onto the substrate to be cleaned.

Despite the attempts in the art to provide concentrated dilution thickening cleaning compositions, there remains a need for dilution thickening compositions that meet the following requirements: 1) an easy to formulate and stable concentrated surfactant composition that is pourable; 2) a concentrated surfactant composition that is easy to dilute by manual shaking or stirring; 3) a concentrated surfactant composition that exhibits an increased viscosity upon dilution compared with the concentrated product; 4) the diluted product exhibits an ideal viscosity that is suitable for an intended application; and 5) a concentrated surfactant composition in which the diluted product exhibits good performance and aesthetic properties (e.g., foaming, cleaning, phase stability and clarity).

### SUMMARY OF THE DISCLOSED TECHNOLOGY

The present technology relates to dilution thickening surfactant concentrates and cleaning compositions prepared from same that meet the forgoing expectations, namely: 1) an easy to formulate highly concentrated surfactant composition that pours easily; 2) a concentrated surfactant composition that is easy to dilute with water and mixed by manual shaking or stirring; 3) a concentrated surfactant composition that exhibits an increased viscosity upon dilution compared with the concentrated initial product; 4) the diluted product exhibits an ideal viscosity that is suitable for an intended application; and 5) a concentrated surfactant composition in which the diluted product that exhibits good performance and aesthetic properties (e.g., foaming, phase stability, cleaning, and clarity).

The concept of dilution thickening describes a phenomenon whereas the formulation thickens upon dilution with a solvent, typically water. A concentrated surfactant containing formulation should be thin enough to easily pour out of a container but becomes sufficiently thick to be retained on a desired substrate during application when water is added.

It is well known in the home care formulation art that a liquid cleaner should have an ideal viscosity. Indeed, viscosity allows for a controlled handling and dispensing of the product during use as compared to a thinner product. In home care applications, viscosity permits better efficacy of the product when applied to non-horizontal surfaces such as toilet bowls, sinks, shower stalls, bathtubs, and the like. In addition, cleaning products are expected to be easy to use. In other words, the shear thinning profile of the liquid composition should exhibit high viscosity at low shear conditions and lower viscosity at high shear conditions to aid in the application and removal of the product from the substrate to be cleaned.

In one aspect, the dilution thickening surfactant concentrate of the present technology comprises: (a) a surfactant chassis comprising (i) a nonionic surfactant component comprising a fatty alcohol ethoxylate and a polysorbate; and (ii) an anionic surfactant component comprising a C₁₀-C₁₆ alkylbenzene sulfonic acid and salts thereof; (b) a polyethoxylated alkyl glucoside ester component; (c) one or more electrolytes; (d) one or more optional benefit agents; and (e) water. Upon the addition of water, the diluted concentrate exhibits a viscosity higher than the viscosity of the initial neat concentrate.

In one aspect, the present technology relates to a neat dilution thickening liquid cleaning concentrate, said neat liquid concentrate comprises:
(a) from about 40 to about 65 wt. % of a surfactant chassis comprising:
   (i) from about 25 to about 56.5 wt. % of a nonionic surfactant component comprising a fatty alcohol ethoxylate component and a polysorbate component, wherein the amount of fatty alcohol ethoxylate ranges from about 90 to about 95 wt. %, and the amount of polysorbate component ranges from about 5 to about 10 wt. % in said nonionic surfactant component;
   (ii) from about 8.5 to about 40 wt. % an anionic surfactant component comprising a C₁₀-C₁₆ alkylbenzene sulfonic acid and salts thereof;
(b) from about 2 to about 6 wt. % of a polyethoxylated alkyl glucoside ester component;
(c) from about 1 to about 5 wt. % of one or more electrolytes;
(d) from about 0 to about 10 wt. %, or from about 1 to about 7 wt. % or from about 3 to about 5 wt. % of one or more benefit agents; and
(e) the remainder water; wherein all weight percentages are based on the total weight of the composition. The neat concentrate upon dilution with water results in a composition with an increased viscosity compared to the neat concentrate.

In one aspect, the present technology relates to a cleaning composition prepared by diluting a neat liquid concentrate with water, said concentrate comprising:
(a) from about 40 to about 65 wt. % of a surfactant chassis comprising:
   (i) from about 25 to about 56.5 wt. % of a nonionic surfactant component comprising a fatty alcohol ethoxylate component and a polysorbate component, wherein the amount of fatty alcohol ethoxylate ranges from about 90 to about 95 wt. %, and the amount of polysorbate component ranges from about 5 to about 10 wt. % in said nonionic surfactant component;
   (ii) from about 8.5 to about 40 wt. % an anionic surfactant component comprising a C₁₀-C₁₆ alkylbenzene sulfonic acid and salts thereof;
(b) from about 2 to about 6 wt. % of a polyethoxylated alkyl glucoside ester component;
(c) from about 1 to about 5 wt. % of one or more electrolytes;
(d) from about 0 to about 10 wt. %, or from about 1 to about 7 wt. % or from about 3 to about 5 wt. % of one or more benefit agents; and
(e) the remainder water; wherein all weight percentages are based on the total weight of the composition.

The dilution thickening surfactant concentrate can be used as a neat concentrate (i.e., before dilution with water), or can be diluted with water to obtain a dilution thickened cleaning product. The neat concentrate and the dilution thickened end-product can be utilized in home care cleaning applications, including but not limited to, laundry pre-spotter stain removal aids, laundry detergents, hard surface cleaners, and manual dish washing detergents.

In one aspect, the dilution thickened compositions and products of the present technology are diluted with an amount of water of at least 2, or at least 3, or at least 4 times the weight of the neat liquid concentrate.

In another aspect, the present technology provides a method for preparing a neat concentrate comprising the steps of:
(a) dissolving an alkylbenzene sulfonic acid component in water;
(b) neutralizing said alkylbenzene sulfonic acid component with a basic material to form an alkylbenzene sulfonate salt component;
(c) dissolving a polyethoxylated alkyl glucoside ester in said alkylbenzene sulfonate salt component formed in step (b);
(d) adding a fatty alcohol ethoxylate to the component formed in step (c); and
(e) dissolving an electrolyte in the component formed in step (d); optionally
(f) adding an optional one or more benefit agent(s) to the component formed in step (e).

### DETAILED DESCRIPTION OF THE DISCLOSED TECHNOLOGY

In all aspects of the disclosed technology, all weight percentages are based on 100 percent active material and are calculated on the basis of the weight of the total composition. All ratios are expressed as weight ratios. All numerical ranges of amounts are inclusive and combinable unless otherwise specified.

While overlapping weight ranges for the various components and ingredients that can be contained in the disclosed compositions have been expressed for selected embodiments and aspects of the disclosed technology, the amount of each component in the disclosed compositions is selected from its disclosed range such that the sum of all components or ingredients in the composition will total 100 weight percent. The amounts employed will vary with the purpose and character of the desired product and can be readily determined by one skilled in the art.

The term “neat” concentrate, product or composition refers to the dilution thickening concentrates of the present technology comprising components (a), (b), (c), and optionally (d) before dilution with water.

By “benefit agent” is meant any compound, material or active ingredient that confers an aesthetic feature in a product in which it is contained or provides a specific effect to the surface of a substrate to which it is delivered.

The term “home care” as used herein includes, without being limited thereto, products employed in a domestic household for surface cleaning or maintaining sanitary conditions, such as in the kitchen and bathroom (e.g., hard surface cleaners, manual and automatic dish care, toilet bowl cleaners and disinfectants), and laundry products for fabric care and cleaning (e.g., detergents, fabric conditioners, pre-spotter stain removers), and the like.

In one aspect, the present technology relates to a neat concentrate for dilution with water, said neat concentrate upon dilution with water results in a composition having an increased viscosity compared to the neat concentrate, said neat concentrate comprises:
(a) from about 40 to about 65 wt. % of a surfactant chassis comprising:
   (i) from about 25 to about 56.5 wt. % of a nonionic surfactant component comprising a fatty alcohol ethoxylate component and a polysorbate component, wherein the amount of fatty alcohol ethoxylate ranges from about 90 to about 95 wt. %, and the amount of polysorbate component ranges from about 5 to about 10 wt. % in said nonionic surfactant component;
   (ii) from about 8.5 to about 40 wt. % an anionic surfactant component comprising a C₁₀-C₁₆ alkylbenzene sulfonic acid, and salts thereof;
(b) from about 2 to about 6 wt. % of a polyethoxylated alkyl glucoside ester component;
(c) from about 1 to about 5 wt. % of one or more electrolytes;
(d) from about 0 to about 10 wt. %, or from about 1 to about 7 wt. % or from about 3 to about 5 wt. % of one or more benefit agents.

In a further aspect, the present technology relates to a dilution thickened neat concentrate diluted with an amount of water of at least 2, or at least 3, or at least 4 times the weight of the neat liquid concentrate, wherein the viscosity of the dilution thickened neat concentrate is greater than the viscosity of the initial neat concentrate.

### Surfactant Chassis—Component (a)

Component (a) of the neat concentrate of the present technology comprises from about 40 to about 65 wt. % of a surfactant chassis comprising: (i) from about 25 to about 56.5 wt. % of a nonionic surfactant component comprising a fatty alcohol ethoxylate component and a polysorbate component; and (ii) from about 8.5 to about 40 wt. % an anionic surfactant component comprising a C₁₀-C₁₆ alkylbenzene sulfonic acid and salts thereof, wherein all weight percentages are based on the weight of the total composition.

In one aspect, the fatty alcohol ethoxylate component (i) of the surfactant chassis is ethoxylated with from about 2 to about 10, or from about 3 to about 8, or from about 5 to about 7 moles of ethylene oxide.

In one aspect, the fatty alcohol ethoxylate of component (i) of the surfactant chassis is selected from a C₁₀-C₁₅ fatty alcohol ethoxylate containing from about 2 to about 10, or from about 3 to about 8, or from about 5 to about 7 moles of ethylene oxide. Such materials are commercially marketed under the Neodol™ trade name by Shell Chemical Company, including Neodol 25-7 and Neodol 23-6.5. Other useful C₁₀-C₁₅ fatty alcohol ethoxylates include Neodol 1-5, an ethoxylated fatty alcohol averaging 11 carbon atoms in its alkyl chain and containing about 5 moles of ethylene oxide; Neodol 23-9, an ethoxylated primary C₁₂-C₁₃ alcohol containing about 9 moles of ethylene oxide. Mixtures of these fatty alcohol ethoxylates can also be used.

Fatty alcohol ethoxylates are also marketed by Shell Chemical Company under the Dobanol™ trade name, including Dobanol 25-7 an ethoxylated C₁₂-C₁₅ fatty alcohol with an average of 7 moles of ethylene oxide per mole of fatty alcohol.

In one aspect, C₁₀-C₁₅ fatty alcohol means that the fatty alcohol contains an average of C₁₀ fatty alcohols, or an average of C₁₁ fatty alcohols, or an average of C₁₂ fatty alcohols, or an average of C₁₃ fatty alcohols, or an average of C₁₄ fatty alcohols, or an average of C₁₅ fatty alcohols, and mixtures thereof, wherein each of said fatty alcohols are ethoxylated with from about 2 to about 10, or from about 3 to about 8, or from about 5 to about 7 moles of ethylene oxide.

In one aspect, mixtures of fatty alcohols selected from two or more of C₁₀, C₁₁, C₁₂, C₁₃, C₁₄, C₁₅ fatty alcohols are utilized, wherein each of the fatty alcohols are ethoxylated with from about 2 to about 10, or from about 3 to about 8, or from about 5 to about 7 moles of ethylene oxide.

The polysorbate of component (i) of the surfactant chassis is selected from polysorbate 20 (polyoxyethylene (20) sorbitan monolaurate), polysorbate 40 (polyoxyethylene (20) sorbitan monopalmitate), polysorbate 60 (polyoxyethylene (20) sorbitan monostearate), polysorbate 80 (polyoxyethylene (20) sorbitan monooleate), and mixtures thereof. The number 20 following the term “polyoxyethylene” indicates the total moles of oxyethylene —(CH₂CH₂O)— groups contained in the molecule. Polysorbates are marketed under the Tween™ and Span™ trade names by Croda Americas LLC.

The amount of fatty alcohol ethoxylate ranges from about 90 to about 95 wt. %, and the amount of polysorbate ranges from about 5 to about 10 wt. % in the nonionic surfactant component (a), based on the weight of the non-ionic component (i).

The anionic surfactant of component (ii) of the surfactant chassis comprises a C₁₀-C₁₆ alkylbenzene sulfonic acid and/or salts thereof, and mixtures thereof. In one aspect, the C₁₀-C₁₆ alkylbenzene sulfonic acid is neutralized in situ with a basic material to form the sulfonate salt or can be employed as a pre-neutralized C₁₀-C₁₆ alkylbenzene sulfonate salt. Suitable basic neutralizing agents include, but are not limited to, alkanolamines, e.g., monoethanolamine (MEA), diethanolamine (DEA), and triethanolamine (TEA), amino alcohols, e.g., 2-amino-2-methyl-1,3-propanediol, 2-amino-2-hydroxymethyl-1,3-propanediol, aminomethyl propanol, and alkali metals, e.g., sodium hydroxide, potassium hydroxide and organiammonium hydroxide. Commercially available C₁₀-C₁₆ alkylbenzene sulfonic acid surfactants (decyl benzene sulfonic acid and dodecyl benzene sulfonic acid) are marketed under the Bio-Soft™ trade name (product designations S-101 and S-118) by the Stepan Company. Non-limiting examples of pre-neutralized C₁₀-C₁₆ alkylbenzene sulfonate surfactants include sodium dodecylbenzene sulfonate, and triethanolamine dodecylbenzene sulfonate which are commercially available from the Stepan Company under the Bio-soft trade name (product designations D-40 and N-300, respectively).

In one aspect, C₁₀-C₁₆ alkylbenzene sulfonic acid or sulfonate means that the acid or sulfonate contains an alkyl group having an average of 10 carbon atoms, or an average of 11 carbon atoms, or an average of 12 carbon atoms, or an average of 13 carbon atoms, or an average of 14 carbon atoms, or an average of 15 carbon atoms, or an average of 16 carbon atoms, and mixtures thereof.

In one aspect, mixtures of C₁₀-C₁₆ alkylbenzene sulfonic acids and/or sulfonates are selected from two or more acids and/or sulfonates having an average of 10 carbon atoms, or an average of 11 carbon atoms, or an average of 12 carbon atoms, or an average of 13 carbon atoms, or an average of 14 carbon atoms, or an average of 15 carbon atoms, or an average of 16 carbon atoms.

The amount of the C₁₀-C₁₆ alkylbenzene sulfonic acid and/or sulfonate ranges from about 8.5 to about 40 wt. % based on the weight of the total composition.

### Polyethoxylated Alkyl Glucoside Ester—Component (b)

In one aspect of the present technology, component (b) is a polyethoxylated alkyl glucoside ester represented by the formula:

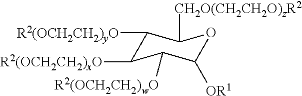

wherein R² is independently selected from H and a saturated and unsaturated C₁₀-C₂₂ acyl group; R¹ is selected from a C₁-C₁₀ alkyl group; and the sum of w+x+y+z ranges from about 60 to about 150, or from about 80 to about 135, or from about 90 to about 125; subject to the proviso that at no more than two of R² can represent H at the same time.

In one aspect, R¹ is a methyl group.

In one aspect, R² is an unsaturated C₁₈ acyl group.

In one aspect, the sum of w+x+y+z is 120.

A suitable polyethoxylated alkyl glucoside ester is commercially available under the trade name Novethix™ HC 220S, marketed by Lubrizol Advanced Materials, Inc.

The amount of the polyethoxylated alkyl glucoside ester component employed in the neat surfactant concentrate of the present technology ranges from about 2 to about 6 wt. %, based on the weight of the total composition.

### Electrolyte—Component (c)

In one aspect of the present technology, the electrolyte component (c) is selected from NaCl, KCl, MgCl₂, MgSO₄, Na₂SO₄, sodium citrate, and mixtures thereof. Generally, the prior art teaches that a dilution thickening effect can be achieved in certain surfactant solutions by using excess amounts of salt (e.g., greater than 5 wt. %). A known problem with using large amounts of salt is that it can lead to a cloudy, hazy, or opaque product, or a product that is prone to phase separation known as “salting out”. Surprisingly, it has been found that reduced levels of electrolyte (from about 5 wt. % or less, or from about 4 wt. % or less, or from about 3 wt. % or less, or from about 2 wt. %) is needed when the surfactant chassis of component (a) is combined with component (b) comprising a polyethoxylated alkyl glucoside ester to prepare the neat surfactant concentrate of the present technology.

In one aspect the amount of electrolyte employed in the neat surfactant concentrates of the present technology ranges from about 1 to about 5 wt. %, or from about 1.5 to about 4 wt. %, or from about 2 to about 3 wt. %, based on the weight of the total composition.

### Benefit Agent—Component (d)

In one aspect, the neat concentrate of the present technology comprises one or more optional benefit agents. Exemplary benefit agents include, but are not limited to, fragrances, fragrance solubilizers, botanicals, antimicrobials, humectants, emollients, enzymes, odor control agents, acidic and alkaline pH adjusting agents, preservatives, buffering agents, coloring agents, hydrotropes, chelating agents, and mixtures thereof.

If the compositions according to the present technology are used for manual dishwashing, the additives can be selected from the list above. However, the compositions according to the invention could be used in different applications (e.g., hard surface cleaners, laundry detergents, and automatic dish). In this regard, suitable additives may include other components like corrosion inhibitors, cationic polymers, anti-static agents, antioxidants, quaternary ammonium compounds, UV absorbers, anti-scale agents, natural oils, silicones, fluorescent whitening agents, photo-bleaches, fiber lubricants, reducing agents, enzymes, enzyme stabilizing agents, powder finishing agents, builders, bleaches, bleach catalysts, soil release agents, dye transfer inhibitors, colorants, rheology modifiers, soil repellents, water-resistance agents, suspending agents, structuring agents, sanitizers, solvents, fabric finishing agents, dye fixatives, fabric conditioning agents, deodorizers, and mixtures thereof.

In one aspect, the amount of benefit agent(s) employed in the neat concentrate ranges from about 0 to about 10 wt. %, or from about 0.5 to about 7 wt. %, or from about 1 to about 5 wt. %, or from about 1.5 to about 3 wt. %, based on the weight of the total composition. The skilled artisan in the home care formulation art can readily determine the amount of one or more benefit agent to use based on the intended application.

### Water Phase—Component (e)

In one aspect, the neat dilution thickening concentrate comprises a minor amount of water as a diluent to facilitate the dissolution of the solid components used to formulate the neat concentrate. In one aspect, deionized (D.I.) water is utilized for the diluent, although dilution water derived from natural, municipal, or commercial sources can be utilized as long as any mineral ions that may be present in such water do not deleteriously affect the intended function of any of the components contained in the neat dilution thickening concentrate.

In one aspect, the amount of water (e) utilized in the neat concentrate comprising components (a), (b), (c), and (d) depends on the sum of the components contained in the concentrated composition. A sufficient amount of water is added to bring the sum of the total component content to 100 weight percent (q.s. to 100%), based on the weight of the total composition.

In one aspect, the water component (e) present in the neat concentrates of the present technology ranges from about 25 to about 40 wt. %, based on the weight of the total composition.

In one non-limiting aspect, the neat dilution thickening concentrate according to the present technology can be prepared by dissolving the alkylbenzene sulfonic acid surfactant component in deionized water in a first mixing vessel, followed by the addition of a neutralizing agent (e.g., TEA) to form the sulfonate salt. To the mixing vessel a polyethoxylated alkyl glucoside ester component is added and dissolved in the aqueous alkylbenzene sulfonate composition. The heat of neutralization liberated by the exotherm of the neutralization reaction of the alkylbenzene sulfonic acid facilitates the dissolution of the polyethoxylated alkyl glucoside ester component in the aqueous alkylbenzene sulfonate. In one aspect, the heat of neutralization raises the temperature of the alkyl benzene sulfonate composition to at least about 50° C., or at least about 55° C., or at least about 60° C., or at least about 65° C., or at least about 70° C., or at least about 75° C. The heat of neutralization eliminates the need to conduct an extraneous heating step during the preparation of the neat concentrate, thus saving energy resources and enhancing production efficiencies. “Extraneous heating” means heating a formulation component(s) from an applied heating source (e.g., heating jacket, heating element, open flame, etc.). The fatty alcohol ethoxylate component is then added to the vessel contents with stirring, followed by the addition of the electrolyte with continued stirring until the electrolyte is dissolved. An optional benefit agent (e.g., a preservative) is added to the composition with stirring until homogeneously dispersed. In a second mixing vessel, the polysorbate component and the optional benefit agent component (e.g., a fragrance) are mixed. The contents of the second mixing vessel are transferred to the first mixing vessel and mixed with its contents until homogeneous giving the neat dilution thickening concentrate.

The neat concentrate of the present technology can be thickened by the end user (consumer) simply by adding water. The water can be obtained from any suitable source such as municipal water, well water, bottled water, rainwater, etc. The amount of water suitable for diluting the neat concentrate to achieve an increase in viscosity ranges from about at least 1, or at least 2, or at least 3, or at least 4 times the weight of the neat concentrate. The consumer simply adds the neat concentrate to the dilution water and manually shakes or stirs the diluted concentrate until homogeneous.

In one aspect, the ideal viscosities for the neat concentrate and the dilution thickened concentrate are set forth in the table below.

| Dilution | Viscosity (cP) | pH | Turbidity (NTU) |
|---|---|---|---|
| Neat Concentrate¹ | 200-500 | 7.5 | 4 |

Dilution Thickened Concentrate²

| | | | |
|---|---|---|---|
| 1:1 | 1500-1800 | 7.4 | 3 |
| 1:2 | 1300-1500 | 7.3 | 3 |
| 1:3 | 1000-1400 | 7.3 | 3 |

¹No dilution water added
²Neat concentrate:dilution water (w/w)

For purposes of illustration a 1:3 dilution comprises 50 g of neat concentrate plus 150 g of dilution water.

The present technology is exemplified by the following examples that are merely for the purpose of illustration and are not to be regarded as limiting the scope of the technology or the way it can be practiced. The amount of all ingredients reported in the tables in the Examples is “as supplied” by the manufacturer. Any ingredient not supplied as 100 percent active material is identified by the active material percentage as supplied by the manufacturer. To calculate the amount of active ingredient utilized in the exemplified composition, multiply the active material percent by the total amount (as supplied) for an ingredient. For example, if an ingredient as supplied by the manufacturer contains 30 wt. % of active polymer material (the remainder is inert carrier).

### Test Methodology

### Viscosity Determination

All viscosity measurements reported herein are conducted by the Brookfield rotating spindle method whether mentioned or not. The viscosity measurements are calculated in cP (mPa·s), employing a Brookfield rotating spindle viscometer, Model DV3T RV (Brookfield Engineering Laboratories, Inc.). The neat concentrate is measured utilizing spindle size no. 2 at 20 revolutions per minute (rpm), and a temperature of 25° C. The diluted concentrate is measured utilizing spindle size no. 3 at 20 revolutions per minute (rpm), and a temperature of 25° C.

### Clarity Measurement

Clarity (turbidity) measurements reported herein are given in Nephelometric Turbidity Units (NTU) employing a nephelometric turbidity meter (Micro 100 Turbidimeter, HF Scientific, Inc.) at ambient room temperature of about 25° C. Distilled water (NTU=0) is utilized as a standard. Six-dram screw cap vials (70 mm×25 mm) are filled almost to the top with test sample and centrifuged at 100 rpm until all bubbles are removed. Upon centrifugation, each sample vial is wiped with tissue paper to remove any smudges before placement in the turbidity meter. The sample is placed in the turbidity meter and a reading is taken. Once the reading stabilizes the NTU value is recorded. The vial is given one-quarter turn and another reading is taken and recorded. This is repeated until four readings are taken. The lowest of the four readings is reported as the turbidity value. In one aspect, compositions having NTU values ranging from at least about 2 to at least about 30 NTU, or from at least about 3 to at least about 25 NTU, or from at least about 4 to at least about 20 NTU, or from at least about 5 to at least about 15 NTU, or from at least about 6 to at least about 10 NTU.

### Stability Testing

The neat concentrates and dilution thickened products made therefrom are stable. The stability requirements for a particular formulation will vary with its end marketplace application as well as the geography in which it is to be bought and sold. An acceptable “shelf life” is subsequently determined for each composition. This refers to the amount of time that a composition should be stable across its normal storage and handling conditions, measured between the time that the composition is produced and when it is finally sold for consumer use. Generally, home care compositions require a one-to-three-year shelf-life.

To eliminate the need to conduct stability studies in excess of one year, the formulator usually conducts stability testing at stressed conditions in order to predict the shelf-life of a composition. Accelerated stability testing is conducted at a depressed temperature by placing test samples in a cooling cabinet (Thermolab Scientific, model no. YGK400SE1B3) maintained at a constant temperature of 5° C., and at an elevated temperature by placing test samples in an aging oven (Mack Pharmatech Pvt Ltd, Model No. MK-21-B1) maintained at a constant 50° C. temperature. A composition should be stable for at least 1-month, or at least 2-months, or at least 3-months at room temperature (≈25° C.), and at the depressed temperature (5° C.). Samples are considered stable at the elevated temperature (50° C.) after only 1-month, due to the very severe temperature parameter.

Products or compositions made according to the present technology are considered stable if they meet parameters 1 through 4 below after accelerated stability testing, and clear if parameter 5 is met during accelerated stability testing:
1. There is no phase separation, settling, or creaming of any material in the composition. The composition should remain completely homogenous throughout its bulk. Separation is herein defined as the visible existence of 2 or more distinct layers or phases of any component in the formulation.
2. The viscosity of the composition does not significantly increase or decrease over time, generally less than 50%, or less than 35%, or less than 20%.
3. The pH of the composition does not increase or decrease more than two pH units, or not more than one pH unit, or not more than one-half pH unit, or not more than 0.5 pH unit.
4. The visible color of the composition should remain constant over the course of the test intervals.
5. The turbidity values should be 30 NTU or less, or 20 NTU or less, or 15 NTU or less, or 10 NTU or less, or 5 NTU or less over the course of the test intervals.

### Example 1

A neat dilution thickening surfactant concentrate was formulated from the ingredients set forth in Table 1.

TABLE 1

| | | | Order |
|---|---|---|---|
| | Wt. | | of |
| Ingredient | % | Function | Addition |
| Water (D.I.) | 28 | Diluent | 1 |
| LABSA¹ | 20 | Anionic Surfactant | 2 |
| TEA² | 14 | Neutralizer | 3 |
| Polyethoxylated Methyl | 4 | Associative | 4 |
| Glucoside Ester³ | | Thickener | |
| NI 7EO⁴ | 27 | Nonionic Surfactant | 5 |
| NaCl | 2 | Electrolyte | 6 |
| Fragrance C7270⁵ | 1 | Fragrance | 7 |
| Polysorbate 20 | 2 | Solubilizer | 7 |
| Phenoxyethanol | 2 | Preservative | 8 |

¹Linear (C₁₀-C₁₆) alkylbenzene sulfonic acid
²Triethanolamine
³Novethix ™ HC220S
⁴Nonionic Surfactant (C₁₂-C₁₃) Alcohol Ethoxylate (condensed with 7 moles ethylene oxide)
⁵Keva, Mumbai, India
⁶Tween ™ 20

The neat dilution thickening surfactant concentrate was prepared by dissolving LABSA in deionized water in a first mixing vessel, followed by the addition of TEA as a neutralizing agent to form the sulfonate salt. The polyethoxylated alkyl glucoside ester component was then added to the vessel and dissolved in the aqueous alkylbenzene sulfonate. The heat of neutralization from the formation of the LABSA sulfonate salt facilitated the dissolution of the polyethoxylated alkyl glucoside ester in the contents of the vessel. The fatty alcohol ethoxylate component was then added to the vessel contents with stirring, followed by the addition of the NaCl electrolyte with continued stirring until dissolved. Phenoxyethanol was then added to the vessel contents under stirring until homogeneously dispersed. In a second mixing vessel, the polysorbate component and the fragrance component were mixed until homogeneous. The contents of the second mixing vessel were then transferred to the first mixing vessel and mixed to give the neat dilution thickening concentrate.

### Example 2

100 g of the neat dilution thickening concentrate prepared in Example 1 was placed into multiple 100 ml polyethylene terephthalate (PET) bottles furnished with screw caps. The samples were aged at room temperature (RT) 5° C., and 50° C. in accordance with the stability testing protocol set forth above. After 24 hours, 1-month, 2-month, and 3-month intervals the samples were removed from the cooling cabinet and aging oven and allowed to equilibrate to RT. Upon reaching RT, the physical properties (viscosity, turbidity, and pH) of the samples were measured and recorded. A sample kept at RT for the test intervals was used as a baseline. In addition, the samples were visually observed for phase separation and color change. The stability results are presented in Table 2.

TABLE 2

| | RT | 5° C. | 50° C. |
|---|---|---|---|
| Test Duration | Stability Parameters and Observations | | |
| 24-Hours. | Transparent; | Transparent; | Transparent; |
| | Pale Yellow Color; | Pale Yellow Color; | Pale Yellow Color; |
| | No Phase Separation; | No Phase Separation; | No Phase Separation; |
| | Viscosity = 410 cP; | Viscosity = 410 cP; | Viscosity = 410 cP; |
| | pH = 7.5; | pH = 7.5; | pH = 7.5; |
| | Turbidity = 4 NTU | Turbidity = 4 NTU | Turbidity = 4 NTU |
| 1-Month | Transparent; | Transparent; | Transparent; |
| | Pale Yellow Color; | Pale Yellow Color; | Pale Yellow Color; |
| | No Phase Separation; | No Phase Separation; | No Phase Separation; |
| | Viscosity = 480 cP; | Viscosity = 450 cP; | Viscosity = 400 cP; |
| | pH = 7.4; | pH = 7.3; | pH = 7.7; |
| | Turbidity = 4 NTU | Turbidity = 4 NTU | Turbidity = 4 NTU |
| 2-Months | Transparent; | Transparent; | Not Tested |
| | Pale Yellow Color; | Pale Yellow Color; | |
| | No Phase Separation; | No Phase Separation; | |
| | Viscosity = 470 cP; | Viscosity = 440 cP; | |
| | pH = 7.3; | pH = 7.5; | |
| | Turbidity = 4 NTU | Turbidity = 4 NTU | |
| 3-Months | Transparent; | Transparent; | Not Tested |
| | Pale Yellow Color; | Pale Yellow Color; | |
| | No Phase Separation; | No Phase Separation; | |
| | Viscosity = 485 cP; | Viscosity = 456 cP; | |
| | pH = 7.3; | pH = 7.5; | |
| | Turbidity = 4 NTU | Turbidity = 4 NTU | |

As exemplified by the results and observations reported in Table 2, the neat concentrate of Example 1 met and passed all of the stability parameters for aging at RT for at least 3-months, accelerated aging at 5° C. for at least 3-months, and accelerated aging at 50° C. for at least 1-month.

### Example 3

100 g of the neat concentrate prepared in Example 1 was diluted with 300 g of D.I. water and mixed by hand with a glass rod stirrer to obtain a 1:3 dilution thickened composition. 100 g samples of the dilution thickened composition was added to multiple 100 ml PET bottles furnished with screw caps. After 24 hours, 1-month, 2-month, and 3-month intervals the samples were removed from the cooling cabinet and aging oven and allowed to equilibrate to RT. Upon reaching RT, the physical properties (viscosity, turbidity, and pH) of the samples were measured and recorded. A sample kept at RT for the test duration intervals was used as a baseline. In addition, the samples were visually observed for phase separation and color change. The stability results are presented in Table 3.

TABLE 3

| | RT | 5° C. | 50° C. |
|---|---|---|---|
| Test Duration | Stability Parameters and Observations | | |
| 24-Hours | Transparent; | Transparent; | Transparent; |
| | Pale Yellow Color; | Pale Yellow Color; | Pale Yellow Color; |
| | No Phase Separation; | No Phase Separation; | No Phase Separation; |
| | Viscosity = 1245 cP; | Viscosity = 1245 cP; | Viscosity = 1245 cP; |
| | pH = 7.5; | pH = 7.5; | pH = 7.5; |
| | Turbidity = 4 NTU | Turbidity = 4 NTU | Turbidity = 4 NTU |
| 1-Month | Transparent; | Transparent; | Transparent; |
| | Pale Yellow Color; | Pale Yellow Color; | Pale Yellow Color; |
| | No Phase Separation; | No Phase Separation; | No Phase Separation; |
| | Viscosity = 1310 cP; | Viscosity = 1289 cP; | Viscosity = 1150 cP; |
| | pH = 7.4; | pH = 7.3; | pH = 7.7; |
| | Turbidity = 4 NTU | Turbidity = 4 NTU | Turbidity = 4 NTU |
| 2-Months | Transparent; | Transparent; | Not Tested |
| | Pale Yellow Color; | Pale Yellow Color; | |
| | No Phase Separation; | No Phase Separation; | |
| | Viscosity = 1330 cP; | Viscosity = 1300 cP; | |
| | pH = 7.3; | pH = 7.5; | |
| | Turbidity = 4 NTU | Turbidity = 4 NTU | |
| 3-Months | Transparent; | Transparent; | Not Tested |
| | Pale Yellow Color; | Pale Yellow Color; | |
| | No Phase Separation; | No Phase Separation; | |
| | Viscosity = 1340 cP; | Viscosity = 1360 cP; | |
| | pH = 7.3; | pH = 7.5; | |
| | Turbidity = 4 NTU | Turbidity = 4 NTU | |

As exemplified by the results and observations reported in Table 3, the dilution thickened composition utilizing the neat concentrate of Example 1 met and passed all of the stability parameters for aging at RT for at least 3-months, accelerated aging at 5° C. for at least 3-months, and accelerated aging at 50° C. for at least 1-month.

1. A neat concentrate for dilution with water, said neat concentrate upon dilution with water results in a composition having an increased viscosity compared to the neat concentrate, said neat concentrate comprises:
(a) from about 40 to about 65 wt. % of a surfactant chassis comprising:
(i) from about 25 to about 56.5 wt. % of a nonionic surfactant component comprising a fatty alcohol ethoxylate component and a polysorbate component, wherein the amount of fatty alcohol ethoxylate ranges from about 90 to about 95 wt. %, and the amount of polysorbate component ranges from about 5 to about 10 wt. % in said nonionic surfactant component;
(ii) from about 8.5 to about 40 wt. % of an anionic surfactant component comprising a C₁₀-C₁₆ alkylbenzene sulfonic acid and salts thereof;
(b) from about 2 to about 6 wt. % of a polyethoxylated alkyl glucoside ester component;
(c) from about 1 to about 5 wt. % of one or more electrolytes;
(d) from about 0 to about 10 wt. % of one or more benefit agents; and
(e) the remainder water; wherein all weight percentages are based on the weight of the total composition.

2. A neat concentrate of claim 1, wherein said water component (e) ranges from about 25 to about 40 wt. %, based on the weight of the total composition.

3. A neat concentrate of claim 1, wherein said anionic surfactant is pre-neutralized with a basic neutralizing agent selected from the group consisting of an alkanolamine; an amino alcohol; and alkali metal.

4. A neat concentrate of claim 1, wherein said fatty alcohol ethoxylate component is selected from a C₁₂-C₁₅ fatty alcohol ethoxylate containing from about 2 to about 10 moles of ethylene oxide.

5. A neat concentrate of claim 1, wherein said polysorbate component is selected from the group consisting of polysorbate 20, polysorbate 40, polysorbate 60, polysorbate 80, and mixtures thereof.

6. A neat concentrate of claim 1, wherein said polyethoxylated alkyl glucoside ester component comprises a compound represented by the formula: 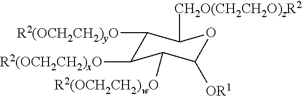
wherein R² is independently selected from H and a saturated and unsaturated C₁₀-C₂₂ acyl group; R¹ is selected from a C₁-C₁₀ alkyl group; and the sum of w+x+y+z ranges from about 60 to about 150; subject to the proviso that at no more than two of R² can represent H at the same time.

7. A neat concentrate of claim 6, wherein in said polyethoxylated alkyl glucoside ester component R¹ is methyl and the sum of w+x+y+z is 120.

8. A neat concentrate of claim 1, wherein said polyethoxylated alkyl glucoside ester component comprises PEG-120 methyl glucose trioleate.

9. (canceled)

10. A neat concentrate of claim 1, having a turbidity value ranging from at least about 2 to at least about 30 NTU.

11. (canceled)

12. A neat concentrate of claim 1, wherein said neat concentrate is selected from the group consisting of a hard surface cleaning product, a manual dish washing detergent, a laundry pre-spotter stain removal aid and a laundry detergent.

13-15. (canceled)

16. A diluted end product comprising the neat concentrate component of claim 1 and an aqueous diluent component, wherein said aqueous diluent component is present in an amount of at least 2 times the weight of the neat concentrate component.

17. A diluted end product of claim 16, wherein said diluted end product has a viscosity that exceeds the viscosity of said liquid concentrate component.

18. A diluted end product of claim 16, wherein said diluted end product is selected from the group consisting of a cleaning product, a manual dish detergent product, a laundry pre-spotter stain removal aid, and a laundry detergent.

19-21. (canceled)

22. A method for preparing a neat concentrate of claim 1 comprising the steps of:
(a) dissolving an C₁₀-C₁₆ alkylbenzene sulfonic acid component in water;
(b) neutralizing said C₁₀-C₁₆ alkylbenzene sulfonic acid component with a basic material to form an alkylbenzene sulfonate salt component;
(c) dissolving a polyethoxylated alkyl glucoside ester in said alkylbenzene sulfonate salt component formed in step (b);
(d) adding a fatty alcohol ethoxylate to the component formed in step (c); and
(e) dissolving an electrolyte in the component formed in step (d); optionally
(f) adding an optional one or more benefit agent(s) to the component formed in step (e).

23. A method for preparing a neat concentrate of claim 22 further comprising the step of (g) adding a polysorbate component and a fragrance component to the component formed in step (e) or (f).

24. (canceled)

25. A method for preparing a neat concentrate of claim 22, wherein said basic material is selected from an alkanolamine.

26. (canceled)

27. A method for preparing a neat concentrate of claim 22, wherein said polyethoxylated alkyl glucoside ester is PEG-120 methyl glucose trioleate.

28. A method for preparing a neat concentrate of claim 22, wherein said fatty alcohol ethoxylate is selected from a C₁₂-C₁₅ fatty alcohol ethoxylate containing from about 2 to about 10, of ethylene oxide, and mixtures thereof.

29. (canceled)

30. A method for preparing a neat concentrate of claim 22, wherein said polysorbate component is selected from the group consisting of polysorbate 20, polysorbate 40, polysorbate 60, polysorbate 80, and mixtures thereof.

31. A method for preparing a neat concentrate of claim 22, wherein said neutralizing step (b) produces an exotherm sufficient to raise the temperature of the alkylbenzene sulfonate salt component to at least about 50° C. to facilitate the dissolution of said polyethoxylated alkyl glucoside ester in step (c).

32. A method for preparing a neat concentrate of claim 22, wherein no extraneous heat is supplied to any of steps (a) through (g).
